(19) United States
(12) Patent Application Publication
(10) Pub. No.: US 2023/0235702 A1
(43) Pub. Date: Jul. 27, 2023

(54) CONNECTING FUEL INJECTORS AND NOZZLES TO MANIFOLDS

(71) Applicant: Delavan Inc., West Des Moines, IA (US)

(72) Inventors: Jason Ryon, Carlisle, IA (US); Gregory A. Zink, Des Moines, IA (US); Brandon Phillip Williams, Johnston, IA (US); Lev A. Prociw, Johnston, IA (US)

(73) Assignee: Delavan Inc., West Des Moines, IA (US)

(21) Appl. No.: 17/581,358

(22) Filed: Jan. 21, 2022

(51) Int. Cl. F02C 7/22

(52) U.S. Cl. CPC F02C 7/222; F05D 2220/32; F05D 2240/35; F05D 2230/60

(57) ABSTRACT

A method includes joining a fuel plurality of injection components to a fuel manifold, wherein for each fuel injection component in the plurality of fuel injection components, a metallic joint is formed joining and sealing the fuel injection component to the manifold. A system includes a fuel manifold. A plurality of fuel injection components are connected in fluid communication with the fuel manifold with metallic joints sealing between each of the plurality of fuel injection components and the fuel manifold to prevent leakage from between the manifold and the plurality of fuel injection components.

### BACKGROUND

### 1. Field

The present disclosure relates to joining methods, and more particularly to joining methods such as used in joining fuel injectors and the like to fuel manifolds such as in gas turbine engines.

### 2. Description of Related Art

Typically, fuel nozzles are connected to an external manifold on a gas turbine engine. These connections are often made using o-rings to seal the joints and threaded or flanged connections to make the mechanical connection. In the case of hot fuels, the temperatures may be too high for polymeric seal materials used in o-rings and would melt them.

The conventional techniques have been considered satisfactory for their intended purpose. However, there is an ever present need for improved systems and methods for joining injectors, nozzles, and the like to fuel manifolds. This disclosure provides a solution for this need.

### SUMMARY

A method includes joining a plurality of fuel injection components to a fuel manifold, wherein for each fuel injection component in the plurality of fuel injection components, a metallic joint is formed joining and sealing the fuel injection component to the manifold.

Joining the plurality of injection components can be performed one injection component at a time. Joining the plurality of injection components can be performed using only local heating to join each of the injection components in the plurality of injection components to the manifold without heating an entire assembly of the manifold and fuel injection components in an oven.

The fuel injection components can be pressure atomizing nozzles. The manifold and pressure atomizing nozzles can be positioned inside a high pressure case of a gas turbine engine and are in fluid communication with a combustion space within a combustor that is inside the high pressure case.

The fuel injection components can be fuel injectors, each including a feed arm and nozzle tip extending from the feed arm, wherein the feed arm is where the fuel injector is joined to the manifold. The fuel manifold can be outside of a high pressure case of a gas turbine engine. The nozzle tips can be inside the high pressure case. The nozzle tips can be in fluid communication with a combustion space within a combustor that is inside the high pressure case.

Joining can include welding. It is also contemplated that joining can include brazing. Joining can include, for each fuel injection component in the plurality of fuel injection components, locally heating a joint portion of the fuel manifold, a joint portion of the fuel injection component, and braze for forming the metallic joint between the joint portion of the fuel manifold and the joint portion of the fuel injection component. Locally heating can include using an induction heater. Using an induction heater can include seating a circumferentially segmented induction coil about one of the joint locations of the manifold and a corresponding joint location of one of the fuel injection components to locally heat the joint locations and form a respective braze joint.

The manifold can be mounted to a gas turbine engine, and joining the plurality of injection components to the manifold can be performed in situ on the gas turbine engine. The method can include for at least one of the injection components, cutting the injection component free from the manifold, and dressing the manifold for repair and/or replacement of the at least one injection component.

A system includes a fuel manifold. A plurality of fuel injection components are connected in fluid communication with the fuel manifold with metallic joints sealing between each of the plurality of fuel injection components and the fuel manifold to prevent leakage from between the manifold and the plurality of fuel injection components.

The fuel manifold can define a main fuel plenum. Each of the plurality of fuel injection components can be connected in fluid communication with the main fuel plenum along a respective fuel path that is devoid of o-ring seals. The metallic joints can be braze joints and/or weld joints.

The fuel injection components can be pressure atomizing nozzles. The manifold and pressure atomizing nozzles can be positioned inside a high pressure case of a gas turbine engine and are in fluid communication with a combustion space within a combustor that is inside the high pressure case.

The fuel injection components can be fuel injectors, each including a feed arm and nozzle tip extending from the feed arm. The feed arm can be where the fuel injector is joined to the manifold. The fuel manifold can be outside of a high pressure case of a gas turbine engine. The nozzle tips can be inside the high pressure case. The nozzle tips can be in fluid communication with combustion space within a combustor that is inside the high pressure case.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a schematic cross-sectional side elevation view of an embodiment of a system constructed in accordance with the present disclosure, showing a manifold and an injector mounted in a gas turbine engine high pressure case and combustor liner;

FIG. 2 is a schematic cross-sectional side elevation view of the manifold and injector of FIG. 1, showing an induction coil for heating the braze joint;

FIG. 3 is a schematic cross-sectional side elevation view of the braze joint of FIG. 2, showing the braze ring;

FIG. 4 is a schematic perspective view of the system of FIG. 1, showing how the induction coil is segmented;

FIG. 5 is a schematic cross sectional perspective view of the system of another embodiment of a system in accordance with the present disclosure, showing a pressure atomizer nozzle mounted to a fuel manifold that can be located inside a high pressure engine case; and

FIG. 6 is a schematic cross-sectional perspective view of the system of FIG. 5, showing a plurality of pressure atomizer nozzles.

### DETAILED DESCRIPTION OF THE PREFERRED EMBODIMENTS

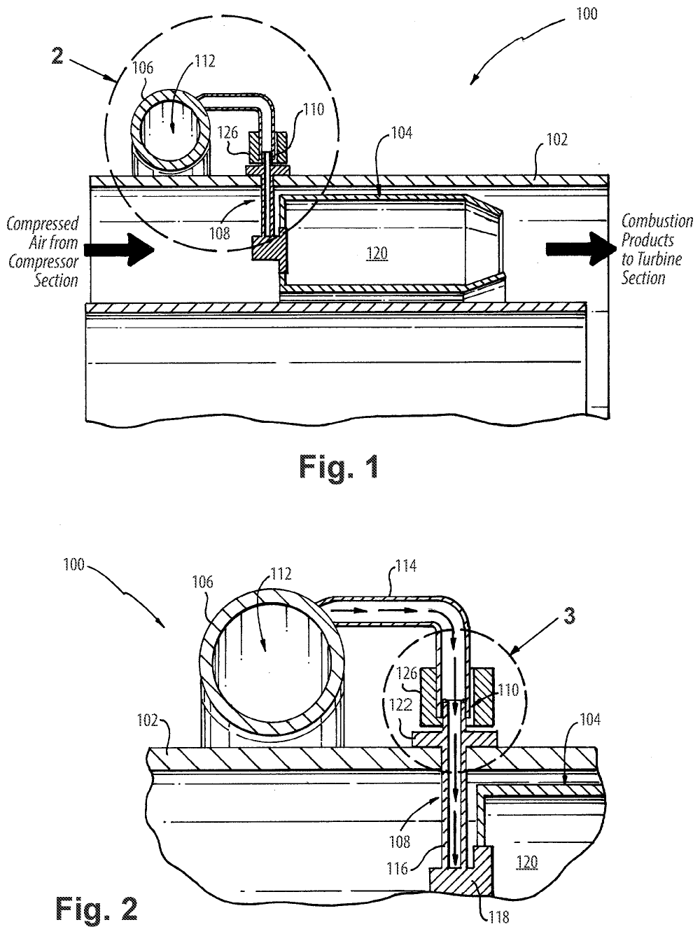

Reference will now be made to the drawings wherein like reference numerals identify similar structural features or aspects of the subject disclosure. For purposes of explanation and illustration, and not limitation, a partial view of an embodiment of a system in accordance with the disclosure is shown in FIG. 1 and is designated generally by reference character 100. Other embodiments of systems in accordance with the disclosure, or aspects thereof, are provided in FIGS. 2-6, as will be described. The systems and methods described herein can be used to connect fuel nozzles and injectors to manifolds without the need for o-ring seals or the like, allowing for higher fuel temperatures than in more traditional systems.

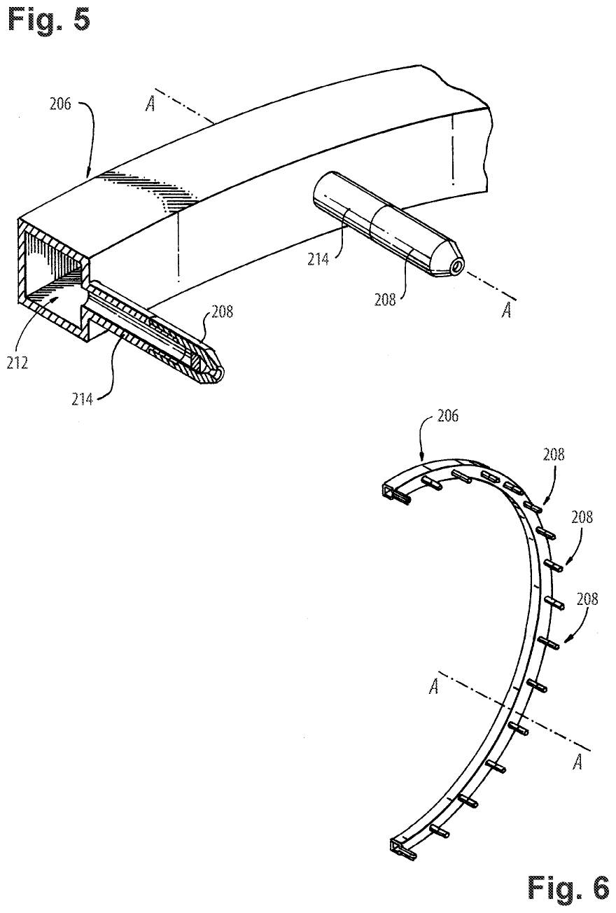

The system 100 includes a high pressure engine case 102 of a gas turbine engine including a compressor section (not pictured in FIG. 1, but indicated by the flow arrow for compressed air flowing in from the compressor section), a combustor 104 in fluid communication to receive the compressed air from the compressor section, and a turbine section (not pictured in FIG. 1, but indicated by the flow arrow for combustion products flowing from the combustor 104 to the turbine section). A fuel manifold 106 is included for supplying fuel for combustion with the compressed air in the combustor 104. A plurality of fuel injection components 108 are connected in fluid communication with the fuel manifold 106 with metallic joints 110 sealing between each of the plurality of fuel injection components 108 and the fuel manifold 106 to prevent leakage from between the manifold 106 and the plurality of fuel injection components 108. Those skilled in the art will readily appreciate that while only one fuel injection component 108 is shown in the cross-section of FIG. 1, the plurality of fuel injection components 108 are distributed circumferentially around the annular space defined by the cross-section in FIG. 1, see, e.g. FIGS. 5-6 below with their circumferential distribution of fuel injection components 208.

With reference now to FIG. 2, the fuel manifold 106 defines a main fuel plenum 112. Each of the plurality of fuel injection components is connected in fluid communication with the main fuel plenum 112 along a respective fuel path that is devoid of o-ring seals or other polymeric seals, where the flow path passes from the plenum 112, through a respective manifold tube 114, and into the respective fuel injection component 108 as indicated in FIG. 2 by the flow arrows. The metallic joints 110 are braze joints and/or weld joints joining each manifold tube 114 to its respective fuel injection component 108.

The fuel injection components 108 are fuel injectors, each including a feed arm 116 and nozzle tip 118 extending from the feed arm 116. The feed arm 116 is where the fuel injector is joined to the manifold 106, i.e. an inlet end of each feed arm 116 is joined at the metallic joint 110 to a respective one of the manifold tubes 114. The fuel manifold 106 is outside of the high pressure case 102, but the nozzle tips 118 are inside the high pressure case 102. The nozzle tips 118 are in fluid communication with combustion space 120 within the combustor 104, which is inside the high pressure case 102. The nozzle tips 118 are configured to atomize fuel from the manifold 106 in a flow of compressor discharge air for combustion in the combustion space 120. A mounting flange 122 extends from the feed arm 116 of each fuel injector, for mounting the feed arm 116 to the high pressure engine case 102, and the feed arm 116 and its internal flow passage pass through the high pressure engine case 102 and through the mounting flange 122.

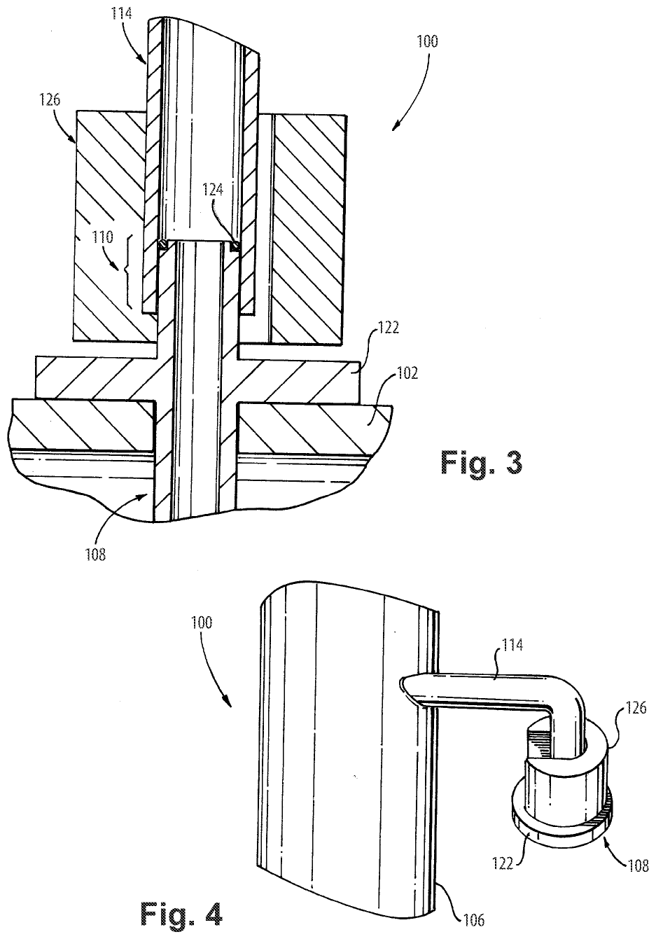

With continued reference to FIG. 3, a method includes joining a fuel plurality of injection components, e.g. fuel injection components 108, to a fuel manifold, e.g. fuel manifold 106, wherein for each fuel injection component in the plurality of fuel injection components, a metallic joint, e.g. metallic joint 110, is formed joining and sealing the fuel injection component to the manifold.

Joining the plurality of injection components is performed one injection component at a time, e.g., each feed arm 116 is joined to its respective manifold tube 114 on an individual basis for each joint 110, rather than heating the entire assembly of the manifold 102 and fuel injectors such as in a brazing oven. Joining the plurality of injection components is performed using only local heating to join each of the injection components to the manifold without having to heat the entire assembly of the manifold and fuel injection components, e.g. in an oven.

Joining can be performed by welding, e.g. welding around the joint 110 to seal the feed arm 108 to the manifold tube 114. It is also contemplated that joining can include brazing. This can include, locally heating a joint portion of the fuel manifold, e.g. an end portion of the manifold tube 114, and a joint portion of the fuel injection component, e.g. the end of the feed arm 116 that is outside the high pressure case 102, and braze, e.g. the braze ring 124 shown in FIG. 3, for forming the metallic joint 110 between the joint portion of the fuel manifold and the joint portion of the fuel injection component. The braze material of the braze ring 124 flows into the joint location of the metallic joint 110 during the brazing process, and when it later cools, the braze joins the manifold 106 to the fuel injection component 108. The local heating can be provided, for example, by using an induction heater 126 to locally heat the joint portions of the manifold tube 114 and fuel injection component 108, and/or the braze ring 124. The induction heater 126 can be circumferentially segmented, e.g. having the c-shaped cross-section shown in FIG. 4 to allow it to be seated around the joint locations of the manifold tubes 114 and feed arms 116 (not visible in FIG. 4 but see FIG. 2). Using the induction heater 126 can include includes seating a circumferentially segmented induction coil about one of the joint locations of the manifold and a corresponding joint location of one of the fuel injection components to locally heat the joint locations and form a respective braze joint. Both components being joined can be metallic, or one can be ceramic.

If the manifold is mounted to a gas turbine engine, joining the plurality of injection components to the manifold can be performed in situ on the gas turbine engine, e.g. by moving the induction coil 126 from manifold tube 114 to manifold tube 114 joining a respective fuel injector to each. If it is ever needed to remove one of the fuel injectors, e.g. for repair or replacement, the injection component can be cut free from the manifold. The cut portion of the manifold can be dressed joining a repaired fuel injector or a replacement injector using techniques as disclosed herein.

With reference now to FIGS. 5-6, a fuel manifold 206 is shown having a fuel plenum 212 similar to manifold 106 above. However, in the case of manifold 206, the fuel injection components 208 are pressure atomizing nozzles, joined to the manifold 206 using techniques as described above. The respective manifold tubes 214 extend in an axial direction A from the fuel plenum 212 to each respective fuel injection component 208. This manifold configuration can allow for the manifold 206 and pressure atomizing nozzles 208 to be positioned inside the high pressure case 102 shown in FIG. 1, and in fluid communication with the combustion space 120, shown in FIG. 1, that is inside the high pressure case 102. It is also contemplated that the pressure atomizing nozzles 208 could instead be nozzle tips, or that the nozzle tips 108 of FIG. 1 could be replaced with pressure atomizing nozzles where the manifold 106 itself is outside of the high pressure case 102.

The methods and systems of the present disclosure, as described above and shown in the drawings, provide for connecting fuel nozzles and injectors to manifolds without the need for o-ring seals, allowing for higher fuel temperatures than in more traditional systems. While the apparatus and methods of the subject disclosure have been shown and described with reference to preferred embodiments, those skilled in the art will readily appreciate that changes and/or modifications may be made thereto without departing from the scope of the subject disclosure.

1. A method comprising:
joining a plurality of fuel injection components to a fuel manifold, wherein for each fuel injection component in the plurality of fuel injection components, a metallic joint is formed joining and sealing the fuel injection component to the manifold by welding or brazing, wherein the fuel injection components are fuel injectors, each including a feed arm and nozzle tip extending from the feed arm, wherein the feed arm is where the fuel injector is joined to the manifold, wherein the fuel manifold is outside of a high pressure case of a gas turbine engine, and wherein the nozzle tips are inside the high pressure case, and wherein the nozzle tips are in fluid communication with a combustion space within a combustor that is inside the high pressure case, wherein the manifold is mounted to a gas turbine engine, and wherein joining the plurality of injection components to the manifold is performed in situ on the gas turbine engine.

2. The method as recited in claim 1, wherein joining the plurality of injection components is performed one injection component at a time.

3. The method as recited in claim 1, wherein joining the plurality of injection components is performed using only local heating to join each of the injection components in the plurality of injection components to the manifold without heating an entire assembly of the manifold and fuel injection components in an oven.

4. The method as recited in claim 1, wherein the fuel injection components are pressure atomizing nozzles.

5. The method as recited in claim 4, wherein the manifold and pressure atomizing nozzles are positioned inside a high pressure case of a gas turbine engine and are in fluid communication with a combustion space within a combustor that is inside the high pressure case.

6-8. (canceled)

10. The method as recited in claim 1, wherein joining includes, for each fuel injection component in the plurality of fuel injection components, locally heating a joint portion of the fuel manifold, a joint portion of the fuel injection component, and braze for forming the metallic joint between the joint portion of the fuel manifold and the joint portion of the fuel injection component.

11. The method as recited in claim 10, wherein locally heating includes using an induction heater.

12. The method as recited in claim 11, wherein using the induction heater includes seating a circumferentially segmented induction coil about one joint locations of the manifold and a corresponding joint location of one of the fuel injection components to locally heat the joint locations and form a respective braze joint.

13. (canceled)

14. The method as recited in claim 1, further comprising for at least one of the injection components, cutting the injection component free from the manifold, and dressing the manifold for repair and/or replacement of the at least one injection component.

15-20. (canceled)
